(19) United States
(12) Patent Application Publication
(10) Pub. No.: US 2011/0173228 A1
(43) Pub. Date: Jul. 14, 2011

(54) AN INFORMATION PROVIDING APPARATUS, AN INFORMATION PROVIDING SYSTEM, AN INFORMATION PROVIDING PROGRAM AND AN INFORMATION PROVIDING METHOD

(75) Inventor: Masafumi Watanabe, Tokyo (JP)

(73) Assignee: NEC CORPORATION, Tokyo (JP)

(21) Appl. No.: 13/119,248

(22) PCT Filed: Aug. 27, 2009
(86) PCT No.: PCT/JP2009/065382

§ 371 Date: Mar. 16, 2011

(30) Foreign Application Priority Data
Sep. 22, 2008 (JP) 2008-242302

(51) Int. Cl. G06F 17/30

(52) U.S. Cl. 707/769; 707/E17.014

(57) ABSTRACT

An information providing apparatus of the present invention prevents searching a database for an object in a narrow area. The apparatus according to one exemplary embodiment of the present invention includes: an information storing means which stores a positional description for each object; a searching means which receives a search request including an area designation, searches, based on the positional description, the information storing means for the object existing in the area and outputs an identifier of the object found; and a checking means which rejects the search request if the area size is not more than a permissible value.

### TECHNICAL FIELD

The present invention relates to an information providing apparatus, an information providing system, an information providing program and an information providing method.

### BACKGROUND ART

In recent years, users using a mobile phone including a position positioning function by GPS (Global Positioning System) and so on or a navigation device are increasing. Service providers are carrying forward investigation of services using a current positional description of users or vehicles and so on (hereinafter, referred to as: users and so on). In these services, service providers search a database system for users and so on who are in a certain area.

A related technology is disclosed in patent document 1. A positional description search system of the document extracts a moving person's terminal which exists in the searching range area designated by an administrator from a positional description storing unit storing a positional description of a moving person's terminal.

In case a search requestor such as a service provider carries out a search for users and so on using a positional description, if the search requestor carries out the search for users and so on focusing on a narrow area, the search requestor can actually go to the place designated as the searching range and specify the users and so on. That is, the search requestor can associate the users and so on searched on a database system and the users and so on in the real world.

For example, suppose that a store assistant of a certain store searches, using a search condition such as “a user who is at present in a specific area in front of the store”, a user positional description database system which a mobile phone provider operates for a user who is in the area concerned. As a result of the search, when an identifier of one user is obtained, by finding one human being in the area concerned in front of the store, the store assistant concerned can associate the human being and one user whose identifier is obtained by the search.

With this association being possible, following two risks arise. The first risk is, by the search requestor's observing the person in question, it is possible to obtain information which is not permitted to obtain from the database system. The second risk is, by the search requestor's obtaining information from the database system, it is possible to obtain information which cannot be obtained from the observation of the person in question.

In the example mentioned above, suppose that one human being found in the specific area in front of the store was female. In that case, even if the database system forbids access to information about sex, the store assistant knows that one user whose identifier is obtained by the search is female.

A similar problem can arise, for example, when a vehicle is searched for designating a narrow area such as a certain specific parking lot. A risk that information about the vehicle searched for is not protected appropriately arises.

In order to settle the problems mentioned above, an example of a method for using a database system so that a search requestor cannot specify the stored information of users and so on is disclosed in patent document 2. An equipment of the document excludes a search condition related to privacy. When there is a search condition such as “family name is Tanaka”, the equipment deletes the condition concerned. Also, the equipment deletes a search condition such as “address is Kobe-shi Hyogo-ku XX-cho YY-chome ZZ-banchi” or converts the search condition into “resident in Kobe” and so on according to a rule set in advance.

Also in patent document 3, a system which prevents acquisition of personal information by using a search keyword and a forbidden keyword together is disclosed.

[Patent document 1] Japanese Patent Application Laid-Open No. 2006-245787

[Patent document 2] Japanese Patent Application Laid-Open No. 2004-318391

[Patent document 3] Japanese Patent Application Laid-Open No. 2000-076295

### DISCLOSURE OF THE INVENTION

### Problem to be Solved

In equipment disclosed in reference literature 2, there is a problem that quantitative size of an area cannot be judged. That is, the equipment cannot judge whether “Kobe-shi Hyogo-ku XX-cho YY-chome ZZ-banchi” is a narrow area such that the association mentioned above can not be hindered. For example, there are cases where a ground such as a wide park or a commercial establishment with a size in which specifying an object is difficult may be designated by an address. To exclude a search condition including such an address will be to impose excessive constraints on a search. Further, the equipment cannot judge whether the size of a search condition “resident in Kobe” which is converted according to a rule set in advance is appropriate. A possibility that a converted search condition is a narrow area for which the association mentioned above cannot be hindered cannot be excluded.

Also, because a technology of reference literature 1 and 3 does not consider at all an area size searched for, the problem mentioned above cannot be solved.

The object of the present invention is to provide an information providing apparatus, an information providing system, an information providing program and an information providing method for solving the problem mentioned above.

### MEANS FOR SOLVING THE PROBLEM

An information providing apparatus according to one exemplary embodiment of the present invention includes: an information storing means which stores a positional description for each object; a searching means which receives a search request including an area designation, searches, based on the positional description, the information storing means for the object existing in the area and outputs an identifier of the object found; and a checking means which rejects the search request if the area size is not more than a permissible value.

An information providing program according to one exemplary embodiment of the present invention makes a computer including an information storing means which stores a positional description for each object execute, searching processing which receives a search request including an area designation, searches, based on the positional description, the information storing means for the objects existing in the area and outputs an identifier of the objects found; and checking processing which rejects the search request if the area size is not more than a permissible value.

In an information providing method according to one exemplary embodiment of the present invention comprises a searching step wherein a computer which comprises an information storing means which stores a positional description for each object, Is receives a search request including an area designation, searches, based on the positional description, the information storing means for the objects existing in the area and outputs an identifier of the object found; and a checking steps wherein the computer rejects the search request if the area size is not more than a permissible value.

### EFFECT OF THE INVENTION

An information providing system of the present invention prevents searching a database for an object in a narrow area.

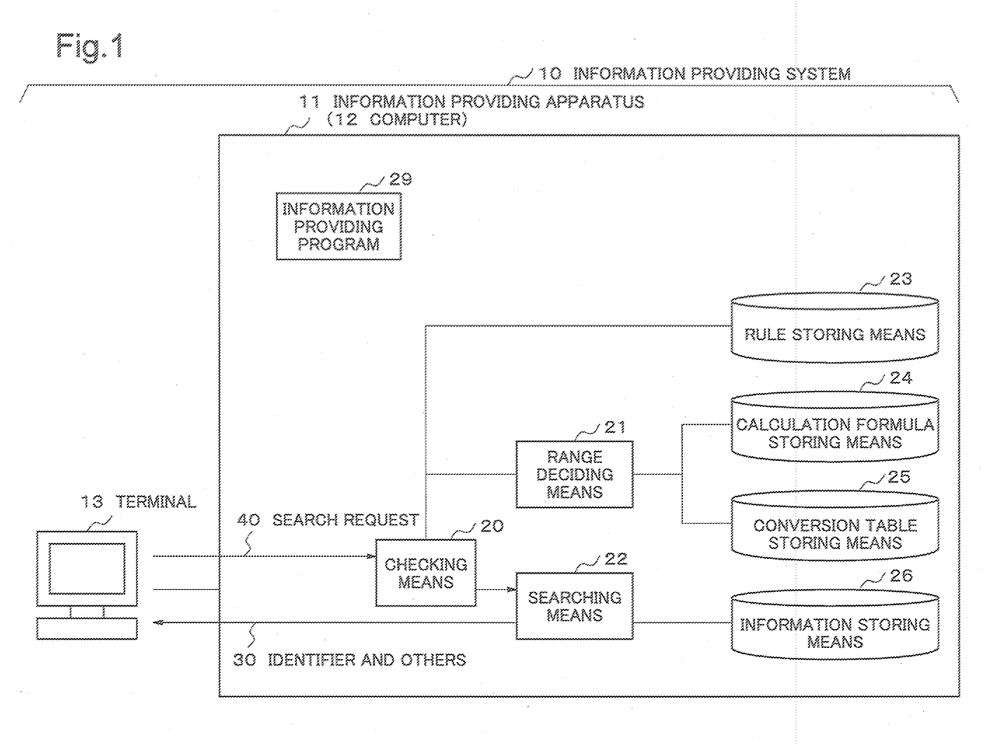

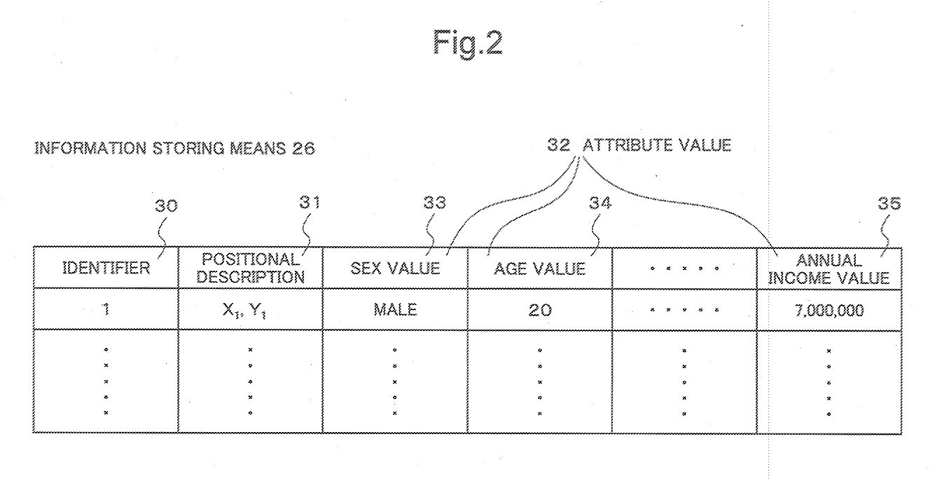

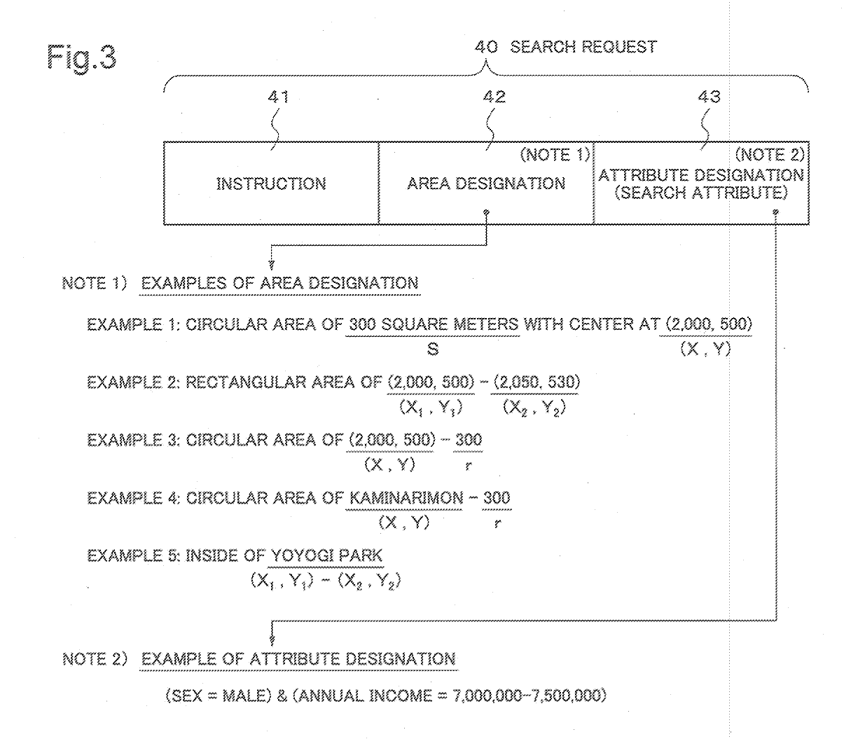

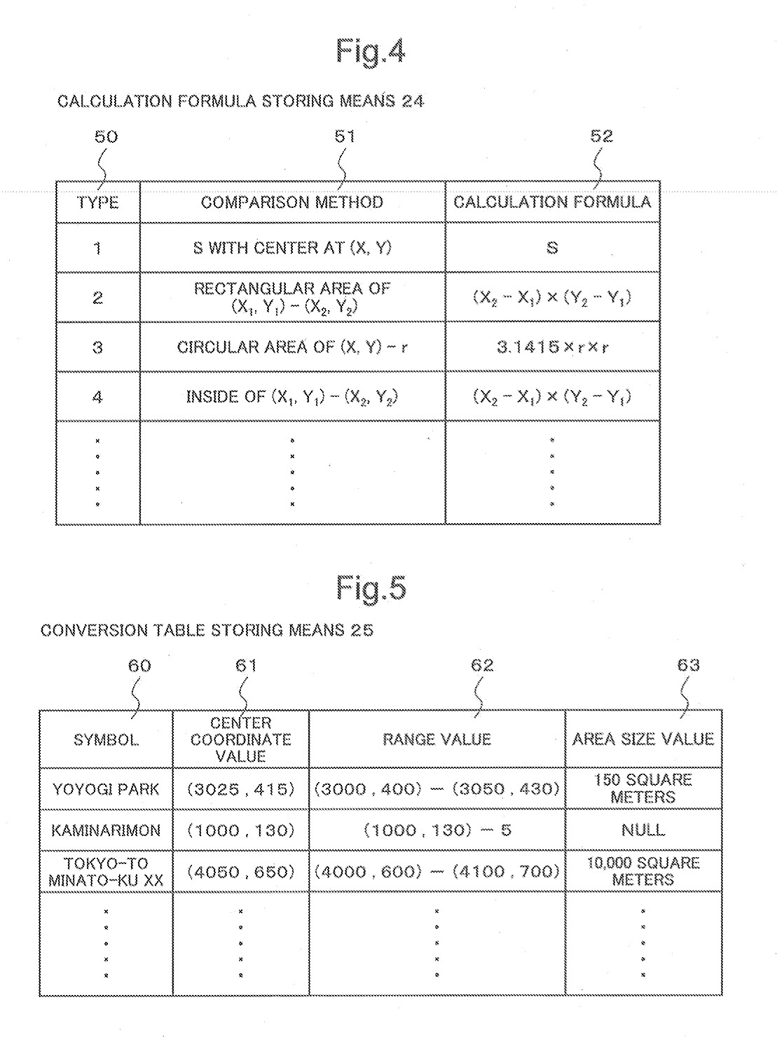

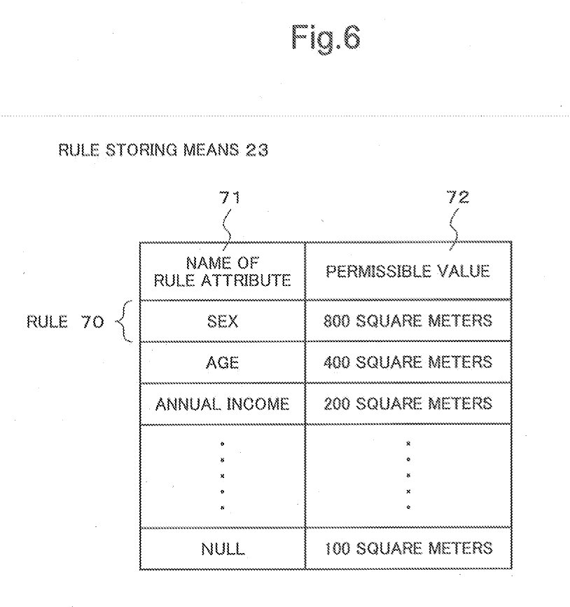

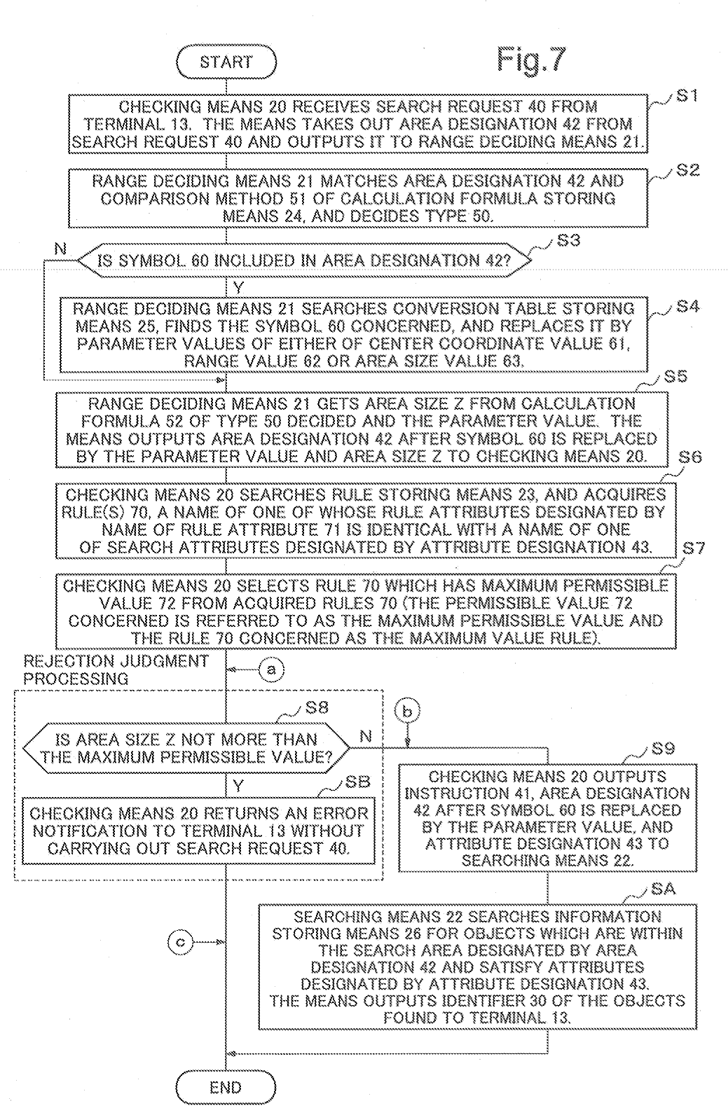

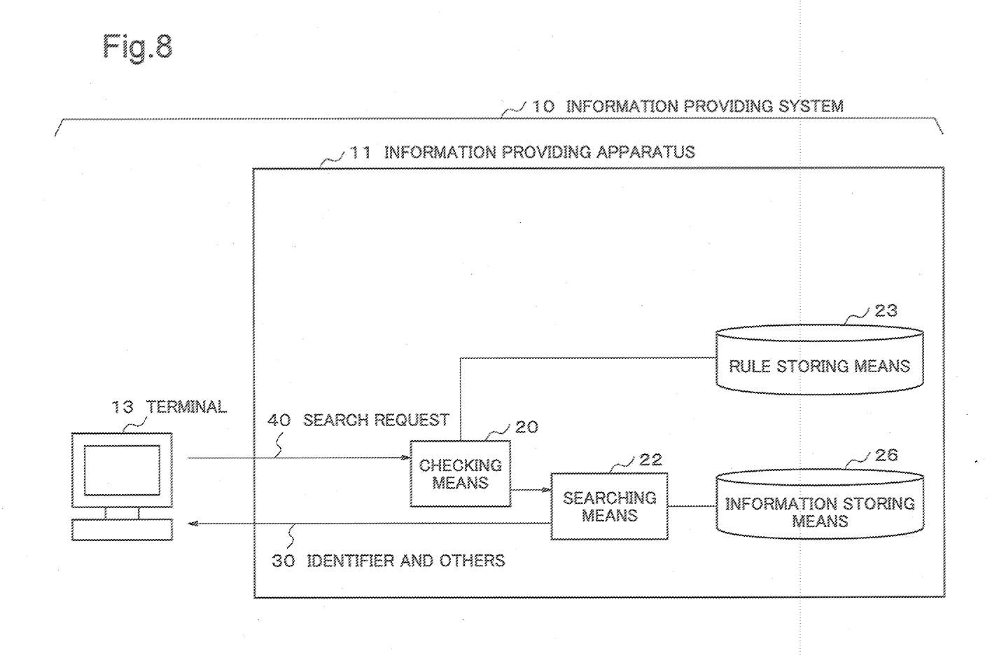

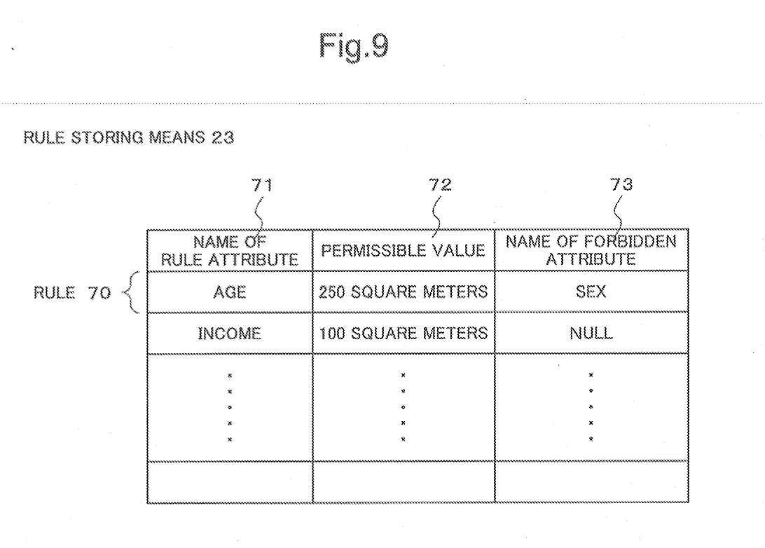

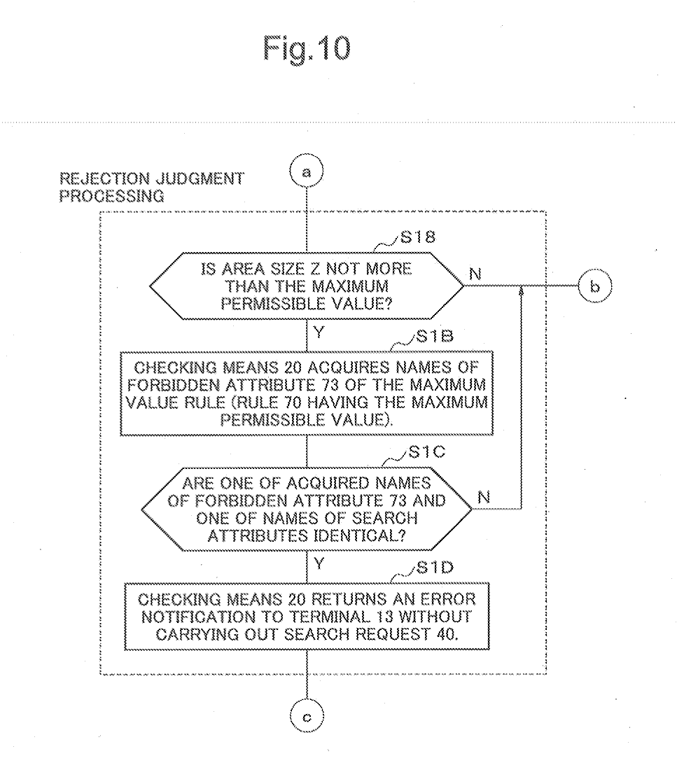

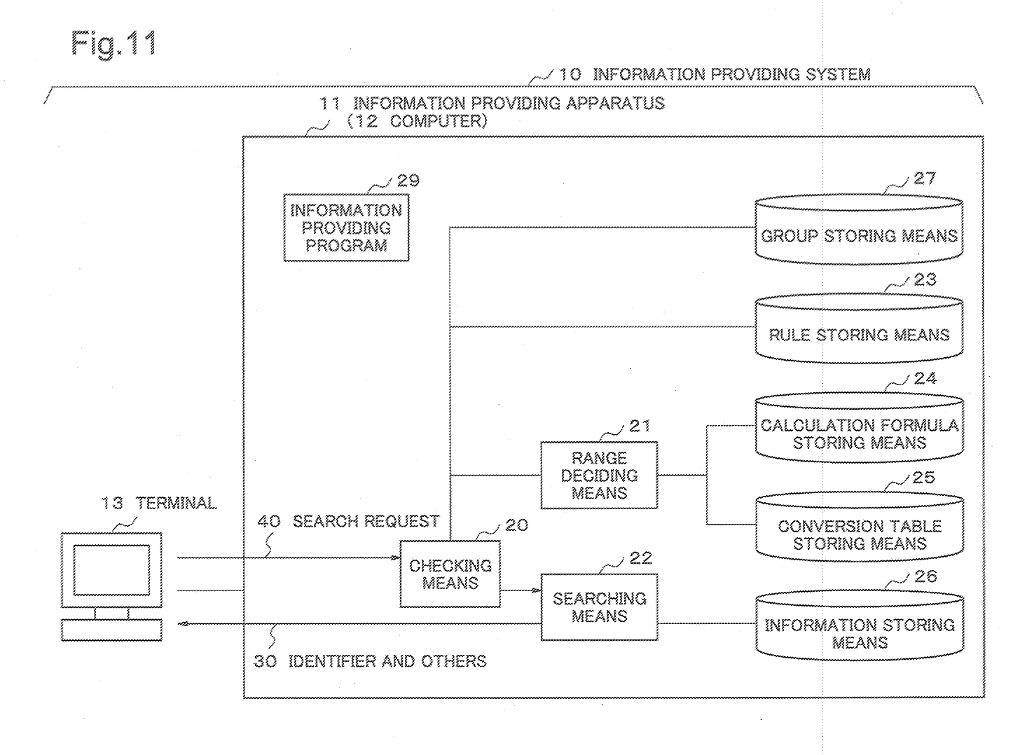

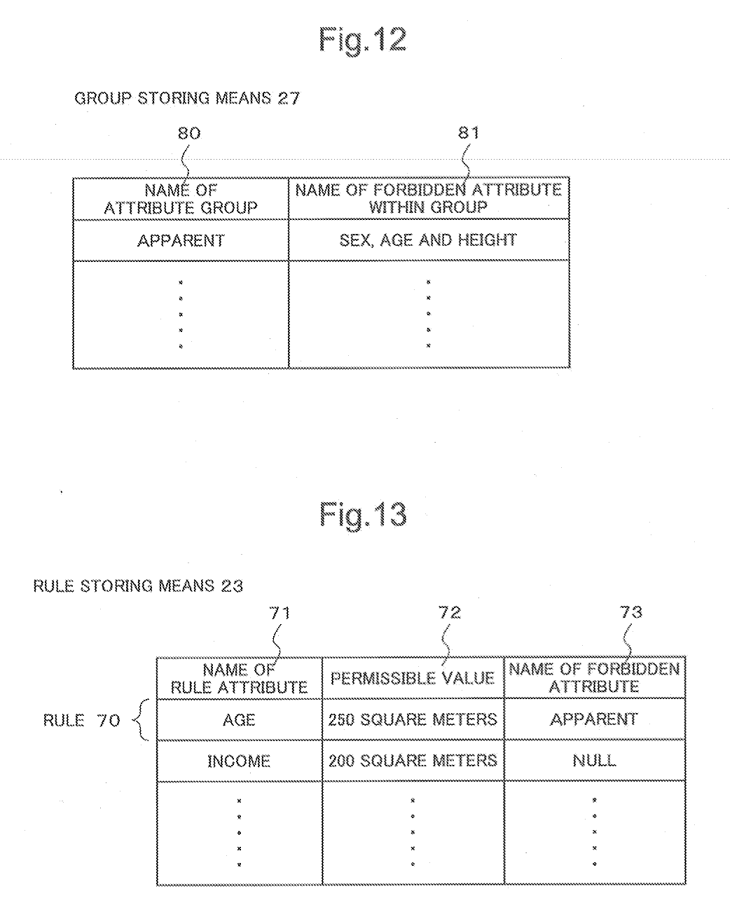

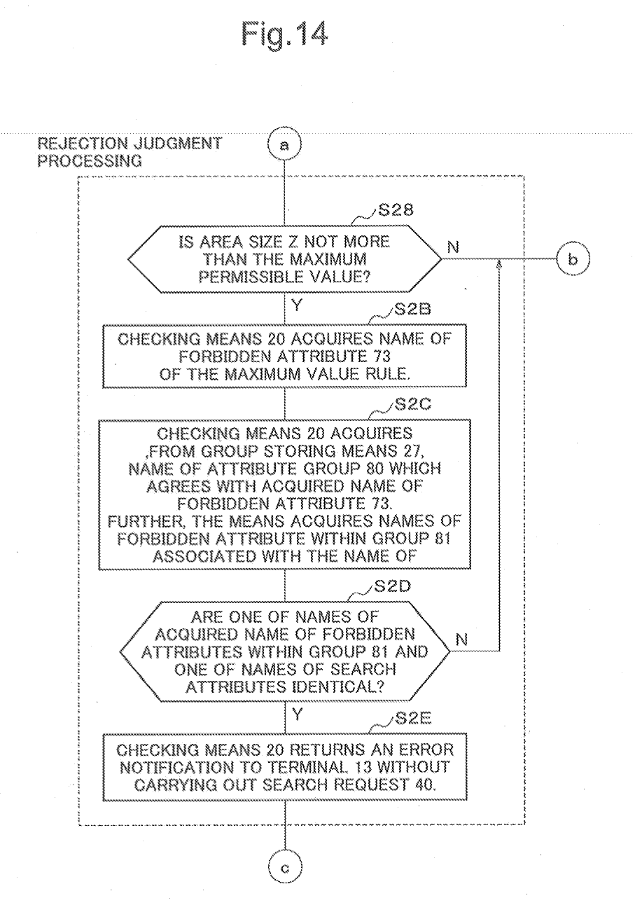

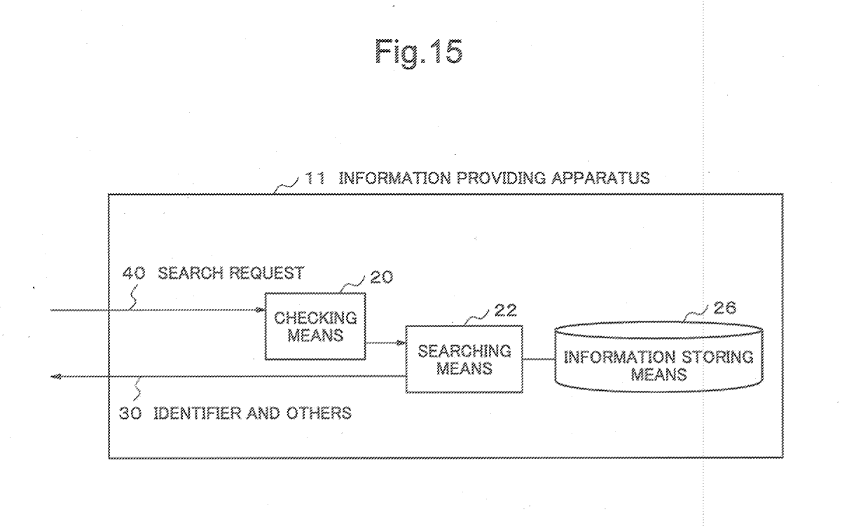

### BRIEF DESCRIPTION OF THE DRAWINGS

[FIG. 1] FIG. 1 indicates a structure of information providing system 10 according to the first exemplary embodiment of the present invention.

[FIG. 2] FIG. 2 indicates data stored in information storing means 26.

[FIG. 3] FIG. 3 indicates a structure of search request 40.

[FIG. 4] FIG. 4 indicates data stored in calculation formula storing means 24.

[FIG. 5] FIG. 5 indicates data stored in conversion table storing means 25.

[FIG. 6] FIG. 6 indicates data stored in rule storing means 23.

[FIG. 7] FIG. 7 is an operation flowchart of information providing apparatus

[FIG. 8] FIG. 8 indicates a structure of information providing system 10 according to the second exemplary embodiment of the present invention.

[FIG. 9] FIG. 9 indicates data stored in rule storing means 23 according to the third exemplary embodiment.

[FIG. 10] FIG. 10 is an operation flowchart of information providing apparatus 11.

[FIG. 11] FIG. 11 indicates a structure of information providing system 10 according to the fourth exemplary embodiment.

[FIG. 12] FIG. 12 indicates data stored in group storing means 27.

[FIG. 13] FIG. 13 indicates data stored in rule storing means 23.

[FIG. 14] FIG. 14 is an operation flowchart of information providing apparatus 11.

[FIG. 15] FIG. 15 indicates a basic configuration of information providing apparatus

### DESCRIPTION OF THE CODE

10 Information providing system

11 Information providing apparatus

12 Computer

13 Terminal

20 Checking means

21 Range deciding means

22 Searching means

23 Rule storing means

24 Calculation formula storing means

25 Conversion table storing means

26 Information storing means

27 Group storing means

29 Information providing program

30 Identifier

31 Positional description

32 Attribute value

33 Sex value

34 Age value

35 Annual income value

40 Search request

41 Instruction

42 Area designation

43 Attribute designation

50 Type

51 Comparison method

52 Calculation formula

60 Symbol

61 Center coordinate value

62 Range value

63 Area size value

70 Rule

71 Name of rule attribute.

72 Permissible value

73 Name of forbidden attribute

80 Name of attribute group

81 Name of forbidden attribute within group

### MOST PREFERRED MODE FOR CARRYING OUT THE INVENTION

FIG. 1 indicates a structure of information providing system 10 according to the first exemplary embodiment of the present invention. Information providing system 10 includes information providing apparatus 11 and terminal 13 connected each other. Information providing apparatus 11 includes checking means 20, searching means 22 and information storing means 26. Information providing apparatus 11 may include range deciding means 21, rule storing means 23, calculation formula storing means 24 or conversion table storing means 25.

Checking means 20 rejects received search request 40 when it has a narrow area as a subject, and when it is not so, transmits it to searching means 22. Search request 40 is received, for example, from terminal 13. Searching means 22 searches information storing means 26 in response to search request 40 and outputs identifier 30 and so on as a search result. Identifier 30 and so on is outputted, for example, to terminal 13 and displayed. Identifier 30 and so on may be outputted to other equipment and so on.

Checking means 20, range deciding means 21 and searching means 22 are realized by hardware as a logic circuit. Checking means 20, range deciding means 21 or searching means 22 may be realized in such a way that a processor of computer 12 as information providing apparatus 11 which is not illustrated reads information providing program 29 from main memory device and carries it out.

Rule storing means 23, calculation formula storing means 24, conversion table storing means 25 and information storing means 26 are external storage device such as a disk or main memory device.

FIG. 2 indicates data stored in information storing means 26. Information storing means 26 associates identifier 30 of an object, positional description 31 and one or plurality of attribute values 32, and stores them. Information storing means 26 may not include identifier 30 of an object, and substitute a line number of the data concerned and so on for it.

Here, an object is one for which a position can be measured and one which has other attributes than a positional attribute. An object is, for example, a human being who possesses a mobile terminal including a GPS function or a vehicle which is equipped with a navigation device. An object may be a human being, an animal or products such as a baggage in a building whose whereabouts is detected by a camera or an IC tag reader arranged plentifully in the building.

Positional description 31 is information which indicates a position of an object. Positional description 31 is, for example, a coordinate data of two dimensions or three dimensions. A coordinate system can be, in addition to latitude, longitude or altitude, in any form such as a floor map of a building.

Positional description 31 is measured by a mobile terminal, a navigation device, a camera or an IC tag reader and so on, and is transmitted to information providing apparatus 11 directly or via a telecommunication carrier server. In information providing apparatus 11, a management means which is not illustrated receives the positional description 31 concerned and stores it in information storing means 26. In case an object moves, the management means concerned updates positional description 31 accompanying the movement.

An object has an attribute. In case an object is a human being, attributes are sex, age, annual income and so on. In case an object is a vehicle, attributes are owner's name, owner's address, accident history, vehicle insurance information, model name and so on. Attribute value 32 stores a value of an attribute of an object. Attribute values 32 are sex value 33, age value 34, annual income value 35 and so on. Further, an attribute of an object has a name respectively (sex, age, annual income and so on). The name is, for example, internally represented by a column number of attribute value 32 of the attribute concerned in information storing means 26.

FIG. 3 indicates a structure of search request 40. Search request 40 is, for example, structured by a character string, and includes instruction 41, area designation 42 and attribute designation 43. Search request 40 is, for example, a request which searches for an object satisfying both of area designation 42 and attribute designation 43. Instruction 41 is a search command character string and so on.

Area designation 42 designates, for information of an object existing in which area (search area) to search information storing means 26. An object searched for is the object in which positional description 31 indicates a position in the search area. Area designation 42 includes a comparison method and parameter values (coordinates, numerical values and so on). Note 1) of FIG. 3 is a specific example of area designation 42. In each specific example, a part not underlined (“with center at”, “circular area of” and so on) is a designation of a comparison method, and a part underlined (“(2,000, 500)”, “300 square meters” and so on) is a parameter value.

Example 1 shows that a circular area having 300 square meters in size with a center at the spot expressed by coordinates (2,000, 500) is a search area. Example 2 shows that a rectangular area which has coordinates (2,000, 500) and (2,050, 530) as diagonal points is a search area. Example 3 shows that a circular area of 300 meters of radius with a center at coordinates (2,000, 500) is a search area.

Area designation 42 may include a symbol instead of a parameter value. Example 4 includes a symbol instead of a first parameter. Example 4 shows that a circular area of 300 meters of radius with a center at Kaminarimon is a search area. Example 5 includes a symbol instead of a first and a second parameter. Example 5 shows that a rectangular area which makes Yoyogi Park as a range is a search area.

Further, in case positional description 31 indicates a three-dimensional space, a search area which area designation 42 indicates will also be a three-dimensional space. In this case, “spherical area of”, “cubic area of” and so on are employed as a designation of a comparison method. Comparison method 51 which designates a three-dimensional space makes three-dimensional coordinates a parameter.

Attribute designation 43 indicates attribute value 32 which an object searched for should have or should not have. Attribute designation 43 includes, for example, a pair of a name of an attribute and a value or range of a value of the attribute concerned. Attribute designation 43 may be such that a logical operation of the pair concerned is possible. Attribute designation 43 may possess syntactic description capability like a general database search language. Note 2) of FIG. 3 is a specific example of attribute designation 43. This example shows that an object of which sex value 33 is male and annual income value 35 is from 7,000,000 yen to 7,500,000 yen should be searched for. Further, an attribute of an object designated in attribute designation 43 is also called a search attribute. Attribute designation 43 may not exist. In this case, for example, all objects in a search area are searched for.

FIG. 4 indicates data stored in calculation formula storing means 24. Calculation formula storing means 24 associates type 50, comparison method 51 and calculation formula 52, and stores them.

Comparison method 51 is, as mentioned above, for example, a character string, and combines identification information of comparison method 51 (for example, “with center at” and so on) and information which specifies a position or a meaning of a parameter value (for example, “(X, Y)”and so on), and stores them. Calculation formula 52 is, for example, a character string, and when associated comparison method 51 is designated, a formula for getting an area size (area size or volume) z is stored. Calculation formula 52 may be a calling address of a calculation function associated with the formula.

For example, calculation formula 52 associated with comparison method 51 where type 50 is “1” (for example, example 1 mentioned above) stores a formula and so on which outputs a value of a second parameter s (300 square meters) just as it is as area size z. Calculation formula 52 of comparison method 51 where type 50 is “2” (example 2 mentioned above) stores a formula and so on which outputs area size z from a value of a first parameter (X1, Y1), (2,000, 500), and a value of a second parameter (X2, Y2), (2,050, 530). Calculation formula 52 associated with comparison method 51 where type 50 is “3” (example 3 mentioned above) stores a formula and so on which outputs area size z from a value of a first parameter (X, Y), (2,000, 500) and a value of a second parameter r, (300 meters). Calculation formula 52 associated with comparison method 51 where type 50 is “4” stores a formula and so on which outputs area size z from a value of a first parameter (X1, Y1) and a value of a second parameter (X2, Y2).

FIG. 5 indicates data stored in conversion table storing means 25. Conversion table storing means 25 associates symbol 60, center coordinate value 61, range value 62 and area size value 63, and stores them. Conversion table storing means 25 may include a volume value. Conversion table storing means 25 is used in order to convert symbol 60 which is included in area designation 42 (refer to example 4 and example 5 of FIG. 3) into parameter values. Center coordinate value 61 is a value used when associated symbol 60 is converted into coordinates. Range value 62 is a value used when associated symbol 60 is converted in a range of an area. Area size value 63 is a value used when associated symbol 60 is converted in area size z.

Which of center coordinate value 61, range value 62 and area size value 63 symbol 60 is converted into is decided, for example, depending on type 50 of comparison method 51 and a position of symbol 60 in comparison method 51.

For example, when symbol 60 is used in a first parameter position of comparison method 51 where type 50 is “3” (example 4 mentioned above), the symbol 60 concerned (Kaminarimon) is converted into center coordinate value 61. For example, when symbol 60 is used in positions of a first and a second parameter of comparison method 51 where type 50 is “4” (example 5 mentioned above), the symbol 60 concerned (Yoyogi Park) is converted into range value 62.

Further, it is not needed that all of center coordinate value 61, range value 62 and area size value 63 are necessarily defined associated with each symbol 60. Values which are not used may be in a state that is not defined (Null).

FIG. 6 indicates data stored in rule storing means 23. Rule storing means 23 stores at least one rule 70. Rule 70 includes name of rule attribute 71 and permissible value 72. Name of rule attribute 71 stores one or plurality of names of an attribute other than a positional attribute of an object. An attribute designated here is also called a rule attribute. When one of a search attribute in search request 40 and one of a rule attribute are identical, the rule 70 concerned is applied to the search request 40 concerned.

Rule 70 without a value (Null) of name of rule attribute 71 may exist. For example, the rule 70 concerned is applied to all search requests 40. The rule 70 concerned is also applied to search request 40 without attribute designation 43.

Permissible value 72 specifies a minimum value of search area size z. Permissible value 72 is given as numerical values (250 square meters and so on).

FIG. 7 is an operation flowchart of the information providing apparatus 11. Checking means 20 receives search request 40 from terminal 13. The means takes out area designation 42 from search request 40, and outputs it to range deciding means 21 (S1). Range deciding means 21 matches area designation 42 and IO comparison method 51 in calculation formula storing means 24, and decides type 50 (S2).

In case symbol 60 is included in area designation 42 (Y in S3), range deciding means 21 searches conversion table storing means 25, finds the symbol 60 concerned, and replaces it by a parameter value of either of center coordinate value 61, range value 62 or area size value 63 associated with the symbol 60 concerned (S4). As is mentioned above, which of center coordinate value 61, range value 62 or area size value 63 is used to replace the symbol 60 concerned, is decided depending on type 50 of comparison method 51 and a position of the symbol 60 concerned. Also, when a plurality of symbols 60 are included in area designation 42, the replacement mentioned above is carried out for each symbol 60.

In case symbol 60 is not included in area designation 42 (N in S3), or after the replacement mentioned above, range deciding means 21 gets area size z from calculation formula 52 of type 50 decided and the parameter value. The means outputs area designation 42 after symbol 60 is replaced by the parameter value and area size z to checking means 20 (S5).

Checking means 20 searches rule storing means 23, and acquires rule 70, a name of one of whose rule attributes designated by name of rule attribute 71 is identical with a name of one of search attributes designated by attribute designation 43 (S6). Here, there are cases where checking means 20 acquires multiple rules 70. In case multiple rules 70 are acquired, checking means 20 selects a rule 70 which has the maximum permissible value 72 from the acquired rules 70 (the permissible value 72 concerned is referred to as the maximum permissible value and the rule 70 concerned is referred to as the maximum value rule respectively) (S7).

In case area size z is not more than the maximum permissible value (Y in S8), checking means 20 returns an error notification to terminal 13 without carrying out search request 40 (S8). In case area size z is more than the maximum permissible value (N in S8), checking means 20 outputs instruction 41, area designation 42 after symbol 60 is replaced by the parameter value, and attribute designation 43 to searching means 22 (S9). Searching means 22 searches information storing means 26 for objects which are within the search area designated by area designation 42 and satisfy attributes designated by attribute designation 43. The means outputs identifier 30 of the objects found to terminal 13 (SA). At this time, the means may output several attribute values 32 of the objects simultaneously.

A searching person may input identifier 30 outputted here to searching means 22, and make it output attribute value 32 of the object specified by the identifier 30 concerned. However, an attribute which a certain searching person can generally output attribute value 32 is limited depending on an access right of the searching person. This limitation is, in case an object is a human being, for privacy protection and so on. This limitation control is, for example, realized by access right information stored in profile information of a searching person and user authentication.

Further, a part enclosed by a wavy line in FIG. 7 (rejection judgment processing) is changed in the following exemplary embodiments.

The effect of information providing apparatus 11 of this exemplary embodiment is as follows.

The first effect is to be able to prevent searching information storing means 26 for an object in a narrow area based on a precise criterion. The reason is because checking means 20 detects that a search area is narrow based on a numerical value of the criterion value (permissible value 72).

The second effect is, while designation of various area designations 42 is made possible, the first effect also takes effect. The reason is because range deciding means 21 gets area size z (numerical value) which can be compared with permissible value 72 from various comparison methods 51 or area designations 42 using symbol 60.

The third effect is prevention of a search is possible which reflects risks depending on a search condition. The reason is because permissible value 72 applied is changed depending on a search attribute. The present invention prevents association of an object searched for and an object in the real world. The risk concerned of a search which designated an attribute which is clear from appearances such as sex is large. On the other hand, the risk concerned of a search which designated an attribute which is unclear from appearances such as an annual income is relatively small. Information providing apparatus 11 can reflect this risk difference in permissible value 72.

Further, range deciding means 21 may associate area designation 42 received from checking means 20, area designation 42 after symbol 60 is replaced, and gotten area size z, and store them. For this purpose, information providing apparatus II may include a temporary storing means which is not illustrated. It is foreseen that a searching person modifies attribute designation 43, and repeats a search in the same search area. In this case, by reusing information in the temporary storing means, it is possible to reduce an amount of processing of the repeated search.

FIG. 8 indicates a structure of information providing system 10 according to the second exemplary embodiment of the present invention. Information providing apparatus 11 of this exemplary embodiment does not include range deciding means 21, calculation formula storing means 24 or conversion table storing means 25. Others are same as the first exemplary embodiment. When area designation 42 includes area size z directly, and does not include symbol 60 (for example, in note 1 of FIG. 3, example 1, or example 2 and example 3 with area size z added as a parameter value), range deciding means 21 becomes unnecessary.

Also, when rule 70 is always only one, rule storing means 23 may not have to be installed. In this case, for example, checking means 20 is structured to store permissible value 72 inside.

The effect of this exemplary embodiment is to be able to implement information providing apparatus 11 at low cost.

Information providing system 10 of the third exemplary embodiment of the present invention prevents association using special features of appearances and so on of an object, that is, association of an object searched for and an object in the real world effectively. This exemplary embodiment introduces a forbidden attribute. A forbidden attribute is, for example, an attribute which can be easily observed from appearances. In case an object is a human being, forbidden attributes are sex, height and so on. In case an object is a vehicle, forbidden attributes are a manufacturer name, color of a body and so on. Information providing system 10 according to the third exemplary embodiment is same as the first exemplary embodiment except for the points described below.

FIG. 9 indicates data stored in rule storing means 23 according to the third exemplary embodiment. Rule 70 of this exemplary embodiment includes name of forbidden attribute 73. Name of forbidden attribute 73 includes one or plurality of names of attribute values 32. There may be cases where name of forbidden attribute 73 is without a value (Null).

FIG. 10 is an operation flowchart of information providing apparatus 11 according to this exemplary embodiment. This figure shows only the rejection judgment processing part. Other parts are same as FIG. 7. Each of a, b and c in the figure corresponds to a, b and c of FIG. 7.

In this exemplary embodiment, in case area size z is not more than the maximum permissible value (Y in S18), checking means 20 acquires names of forbidden attribute 73 of the maximum value rule (rule 70 having the maximum permissible value) (SIB). When one of acquired names of forbidden attribute 73 and one of names of search attributes are identical (Y in SIC), checking means 20 returns an error notification to terminal 13 without carrying out search request 40 (SID). When the name of acquired name of forbidden attribute 73 and the name of the search attribute are not identical (N in SIC), checking means 20 outputs a search request to searching means 22. In case a stored value of acquired name of forbidden attribute 73 is Null, it is also the same (N in SIC).

Information providing apparatus 11 of this exemplary embodiment prevents association of an object searched for and an object in the real world effectively without imposing excessive constraints on search request 40. The reason is because search area size z of search request 40 only using a forbidden attribute as a search attribute is checked.

Information providing system 10 of the fourth exemplary embodiment of the present invention introduces a forbidden attribute group. Information providing system 10 according to this exemplary embodiment is same as the first exemplary embodiment except for the points described below.

FIG. 11 indicates a structure of information providing system 10 according to the fourth exemplary embodiment. Information providing apparatus 11 of this exemplary embodiment includes group storing means 27. Group storing means 27 is an external storage device such as a disk or a main memory device.

FIG. 12 indicates data stored in group storing means 27. Group storing means 27 associates name of attribute group 80 and name of forbidden attribute within group 81, and stores them. Name of forbidden attribute within group 81 generally includes a plurality of names of attributes. Name of forbidden attribute within group 81 may include a name of one attribute or there may be cases with no values (Null).

FIG. 13 indicates data stored in rule storing means 23. Each rule 70 stored in rule storing means 23 of this exemplary embodiment includes name of forbidden attribute 73. Rule 70 of this exemplary embodiment includes, as name of forbidden attribute 73, one or plurality of names of attribute group 80. There may be cases where name of forbidden attribute 73 has no values (Null).

FIG. 14 is an operation flowchart of information providing apparatus 11 according to this exemplary embodiment. This figure shows only the rejection judgment processing part. Other parts are same as FIG. 7. Each of a, b and c in the figure corresponds to a, b and c of FIG. 7.

In this exemplary embodiment, in case area size z is not more than the maximum permissible value (Y in S28), checking means 20 acquires name of forbidden attribute 73 of the maximum value rule (S2B). Checking means 20 acquires, from group storing means 27, name of attribute group 80 which agrees with acquired name of forbidden attribute 73. Further, the means acquires names of forbidden attributes within group 81 associated with the name of attribute group 80 concerned (S2C). When one of acquired names of forbidden attributes within group 81 and one of names of search attributes are identical (Y in S2D), checking means 20 returns an error notification to terminal 13 without carrying out search request 40 (S2E). When the name of acquired name of forbidden attribute within group 81 and the name of the search attribute are not identical (N in S2D), checking means 20 outputs a search request to searching means 22. In case acquired name of forbidden attribute 73 or name of forbidden attribute within group 81 is Null, it is also the same (N in S2D).

Information providing system 10 of this exemplary embodiment takes effect that maintenance and management of rule 70 become easy. The reason is because group storing means 27 associates a plurality of forbidden attributes with one name of attribute group 80, and stores them. Accordingly, only one name of attribute group 80 needs be described instead of enumerating a plurality of attribute names in name of forbidden attribute 73 included in rule 70.

FIG. 15 indicates a basic configuration of information providing apparatus 11 according to the present invention. Information providing apparatus 11 includes information storing means 26, searching means 22 and checking means 20. Information storing means 26 associates identifier 30 of an object and positional description 31, and stores them. Searching means 22 receives search request 40 including area designation 42, searches, based on positional description 31, information storing means 26 for objects existing in the area, and outputs identifier 30 of the objects found. Checking means 20 rejects search request 40 in case area size z is not more than permissible value 72.

As stated above, the present invention has been described with reference to an exemplary embodiment. However, the present invention is not limited to the exemplary embodiment mentioned above. Various changes can be performed in the composition of the present invention and details within the scope of the present invention and to the extent a person skilled in the art can understand.

This application claims priority based on Japanese Patent Application No. 2008-242302 filed on Sep. 22, 2008 and the disclosure thereof is incorporated herein in its entirety.

1-22. (canceled)

23. An information providing apparatus comprising: an information storing unit which stores a positional description for each object;
a checking unit which receives a search request including an area designation, and outputs the search request to a searching unit if the area size is more than a permissible value but otherwise rejects the search request; and
the searching unit which receives the search request from the checking unit, searches, based on the positional description, the information storing unit for the object existing in the area and outputs an identifier of the object found.

24. The information providing apparatus according to claim 23 further comprising:
a range deciding unit which calculates the size from a symbol or coordinates included in the area designation.

25. The information providing apparatus according to claim 24 further comprising:
a rule storing unit which stores a rule including a name of one of a plurality of attributes and the permissible value; wherein
the information storing unit further stores a value of each attribute of the plurality of attributes for each of the objects,
the checking unit receives the search request which designates a name and a value of an attribute (search attribute) and outputs the search request if the size is more than the permissible value included in the rule with a name of its attribute (rule attribute) which agrees with the name of the search attribute, and
the search unit receives the search request, searches, based on the value of an attribute and the positional description, the information storing unit for the object in the area.

26. The information providing apparatus according to claim 25, wherein
the rule includes a name of an attribute (forbidden attribute) which is other than the rule attribute, and
the checking unit outputs the search request if the size is more than the permissible value included in the rule with a name of the forbidden attribute which agrees with the name of the search attribute.

27. The information providing apparatus according to claim 26 further comprising:
a group storing unit which includes names of the forbidden attributes for each attribute group, wherein
the rule includes the name of an attribute group, and
the checking unit outputs the search request if the size is more than the permissible value included in the rule with a name of the attribute group which includes the name of the forbidden attribute which agrees with the name of the search attribute.

28. The information providing apparatus according to claim 27 further comprising:
a calculation formula storing unit which stores a comparison method and a calculation formula, associated with each other, wherein
the area designation includes a designation of the comparison method; and
the range deciding unit calculates the size using the calculation formula which is stored in the calculation formula storing unit associated with the comparison method included in the area designation, and the coordinates included in the area designation.

29. The information providing apparatus according to claim 28 further comprising:
a conversion table storing unit which stores the coordinates associated with the symbol; wherein
the range deciding unit calculates the size using the calculation formula of the calculation formula storing unit associated with the method included in the area designation, and the coordinates of the conversion table storing unit associated with the symbol included in the area designation.

30. An information providing system comprising:
an information providing apparatus according to claim 27; and
the terminal which receives the search request and outputs it to the information providing apparatus, and receives the identifier of the object found from the information providing apparatus and displays them.

31. A non-transient computer-readable recording medium which records an information providing program which makes a computer function as:
an information storing unit which stores a positional description for each object;
a checking unit which receives a search request including an area designation, and outputs the search request to a searching unit if the area size is more than a permissible value but otherwise rejects the search request; and
the searching unit which receives the search request from the checking unit, searches, based on the positional description, the information storing unit for the object existing in the area and outputs an identifier of the object found.

32. The non-transient computer-readable recording medium according to claim 31 which records the information providing program which makes the computer function further as
a range deciding unit which calculates the size from a symbol or coordinates included in the area designation.

33. The non-transient computer-readable recording medium according to claim 32 which records the information providing program which makes the computer function as
a rule storing unit which stores a rule including a name of one of a plurality of attributes and the permissible value;
the information storing unit which further stores a value of each attribute of the plurality of attributes for each of the objects;
the checking unit which receives the search request which designates a name and a value of an attribute (search attribute) and outputs the search request if the size is more than the permissible value included in the rule with a name of its attribute (rule attribute) which agrees with the name of the search attribute, and
the search unit which receives the search request, searches, based on is the value of an attribute and the positional description, the information storing unit for the object in the area.

34. The non-transient computer-readable recording medium according to claim 33 which records the information providing program, wherein the rule includes a name of an attribute (forbidden attribute) which is other than the rule attribute, and which makes the computer function as
the checking unit outputs the search request if the size is more than the permissible value included in the rule with a name of the forbidden attribute which agrees with the name of the search attribute.

35. The non-transient computer-readable recording medium according to claim 34 which records the information providing program, wherein the rule includes the name of an attribute group, and which makes a computer function as
a group storing unit which includes names of the forbidden attributes for each attribute group, and
the checking unit which outputs the search request if the size is more than the permissible value included in the rule with a name of the attribute group which includes the name of the forbidden attribute which agrees with the name of the search attribute.

36. The non-transient computer-readable recording medium according to claim 35 which records the information providing program, wherein the area designation includes a designation of the comparison method, and which makes a computer function as
a calculation formula storing unit which stores a comparison method and a calculation formula, associated with each other; and
the range deciding unit calculates the size using the calculation formula which is stored in the calculation formula storing unit associated with the comparison method included in the area designation, and the coordinates included in the area designation.

37. The non-transient computer-readable recording medium according to claim 36 which records the information providing program which makes the computer function as
a conversion table storing unit which stores the coordinates associated with the symbol; and
the range deciding unit which calculates the size using the calculation formula of the calculation formula storing unit associated with the method included in the area designation, and the coordinates of the conversion table storing unit associated with the symbol included in the area designation.

38. An information providing method wherein a computer . comprising an information storing unit:
storing a positional description for each object in the information storing unit;
receiving a search request including an area designation,
searching, based on the positional description, the information storing unit for the object existing in the area and outputs an identifier of the object found if the area size is more than a permissible value, but otherwise rejecting the search request.

39. The information providing method according to claim 38 wherein the computer:
calculating the size from a symbol or coordinates included in the area designation.

40. The information providing method according to claim 39 wherein the computer:
storing a rule including a name of one of a plurality of attributes and the permissible value in a rule storing unit,
storing a value of each attribute of the plurality of attributes for each of the objects in the information storing unit,
receiving the search request which designates a name and a value of an attribute (search attribute) and searching, based on the value of an attribute and the positional description, the information storing unit for the object in the area if the size is more than the permissible value included in the rule with a name of its attribute (rule attribute) which agrees with the name of the search attribute.

41. The information providing method according to claim 40 wherein the computer:
storing the rule which includes a name of an attribute (forbidden attribute) which is other than the rule attribute in the rule storing unit, and
searching, based on the value of an attribute and the positional description, the information storing unit for the object in the area if the size is more than the permissible value included in the rule with a name of the forbidden attribute which agrees with the name of the search attribute.

42. The information providing method according to claim 41 wherein the computer further comprising a group storing unit:
storing names of the forbidden attributes for each attribute group in the group storing unit,
storing the rule which includes the name of attribute group in the rule storing unit, and
searching, based on the value of an attribute and the positional description, the information storing unit for the object in the area if the size is more than the permissible value included in the rule with a name of the attribute group which includes the name of the forbidden attribute which agrees with the name of the search attribute.
